(19) United States
(12) Patent Application Publication
(10) Pub. No.: US 2018/0357029 A1
(43) Pub. Date: Dec. 13, 2018

(54) PERSONAL DEVICE CONTROL PORTAL

(71) Applicant: Panasonic Automotive Systems Company of America, Division of Panasonic Corporation of North America, Peachtree City, GA (US)

(72) Inventors: ANDREW BIANCHI, PLEASANT RIDGE, MI (US); PADMANABAN KANAGARAJ, FARMINGTON HILLS, MI (US); SACHIKO KOBAYASHI, NOVI, MI (US); BEN ZULLO, HAMTRAMCK, MI (US); MARTIN NESPOLO, GROSSE POINTE WOODS, MI (US)

(73) Assignee: Panasonic Automotive Systems Company of America, Division of Panasonic Corporation of North America

(21) Appl. No.: 16/000,993

(22) Filed: Jun. 6, 2018

Related U.S. Application Data
(60) Provisional application No. 62/518,060, filed on Jun. 12, 2017.

(51) Int. Cl. G06F 3/14; G06F 3/0488; B60R 1/00

(52) U.S. Cl. CPC G06F 3/1423; B60R 2300/20; B60R 1/00; G06F 3/0488

(57) ABSTRACT

A motor vehicle includes a display screen viewable by a driver of the motor vehicle. An electronic processor is communicatively coupled to the display screen. The electronic processor bi-directionally communicates with a plurality of personal electronic devices brought into the vehicle by a plurality of passengers, and presents on the display screen an indication of content being played on each of the personal electronic devices.

### CROSS-REFERENCE TO RELATED APPLICATIONS

This application claims the benefit of U.S. Provisional Application No. 62/518,060, filed on Jun. 12, 2017, which the disclosure of which is hereby incorporated by reference in its entirety for all purposes.

### FIELD OF THE INVENTION

The disclosure relates to a human machine interface in a motor vehicle, and, more particularly, to a human machine interface that communicates with the personal electronic devices of occupants of the vehicle.

### BACKGROUND OF THE INVENTION

More people are bringing their own personal electronic devices into vehicles to serve as a means of rear seat entertainment, etc. However, certain passengers, such as a toddler or infant sitting in the rear seat, are not always able to operate the devices.

Known solutions offer a means to control the device with limited functionality. For example, the song playing on a mobile phone can be changed by operating a car's center stack buttons. However, only one device can be changed at a time and is usually the driver's device. There is no known way to enable an adult to remotely and safely control a child's brought-in device. Nor is there any known intra-vehicle system for sharing and viewing infotainment content between the personal electronic devices of the occupants of a vehicle.

One known way for an adult to see the children in the rear seat is the use of two mirrors in the car. Through research, this solution has been deemed inadequate for the driver because of alignment issues, mounting issues, etc.

### SUMMARY

When a child is using a personal electronic device in the rear seat, the present invention may enable an adult in the front seat to control, monitor, and tend to the device in a safe matter without having to physically reach into the rear of the passenger compartment in order to adjust the device for the child. The invention may also enable the adult in the front seat to safely view the child in the rear seat. In addition, as the rear seat experience begins to rely more on brought-in devices rather than on one large screen that everyone looks at, the present invention may enable the occupants to still have a shared experience in the car through intra-vehicle electronic content sharing.

The present invention may provide an integrated vehicle human machine interface (HMI) system and device application that enables an occupant of a vehicle, by use of the centerstack, to remotely control, monitor and access content and applications on devices that are brought into the vehicle and linked into the vehicle system. The invention also enables the centerstack to switch from being controlled by the device to being controlled by the vehicle for monitoring things like car climate and trip information. There may be a wired or wireless connection between the device and the vehicle. The vehicle-side system may include an overview screen integrated into a native vehicle HMI showing all devices in the vehicle and a portal view of what is appearing on each of these brought-in devices. Thus, the invention may provide control of the devices through the vehicle. Through this portal on the vehicle, the occupant can also access the brought-in device's native camera to achieve an intra-vehicle monitoring of occupants. From the device side, occupants who are linked into the intra-vehicle system may be able to see the statuses and content of other occupants' devices, and can choose to share their own content with the intra-vehicle community of linked devices and with other occupants.

In one embodiment, the invention comprises a motor vehicle including a display screen viewable by a driver of the motor vehicle. An electronic processor is communicatively coupled to the display screen. The electronic processor bi-directionally communicates with a plurality of personal electronic devices brought into the vehicle by a plurality of passengers, and presents on the display screen an indication of content being played on each of the personal electronic devices.

In another embodiment, the invention comprises a method of providing infotainment within a motor vehicle, including providing a touch-sensitive display screen viewable by a driver of the motor vehicle. An electronic processor is communicatively coupled to the display screen. The electronic processor is communicatively coupled with a plurality of personal electronic devices brought into the vehicle by a plurality of passengers. An indication of content being played on each of the personal electronic devices is presented on the display screen. In response to the driver touching the display screen, the content being played on one of the personal electronic devices is changed.

In yet another embodiment, the invention comprises a motor vehicle including a display screen viewable by a driver of the motor vehicle. An electronic processor is communicatively coupled to the display screen. The electronic processor bi-directionally communicates with a plurality of personal electronic devices brought into the vehicle by a plurality of passengers. The electronic processor presents on the display screen an indication of content being played on each of the personal electronic devices. The electronic processor presents on the display screen an image captured by a camera of one of the personal electronic devices.

In yet another embodiment, the invention comprises a motor vehicle including a display screen viewable by a driver of the motor vehicle. An electronic processor is communicatively coupled to the display screen. The electronic processor bi-directionally communicates with a plurality of personal electronic devices brought into the vehicle by a plurality of passengers, and selectively presents same content on the display screen and on each of the personal electronic devices simultaneously.

### BRIEF DESCRIPTION OF THE DRAWINGS

A better understanding of the present invention will be had upon reference to the following description in conjunction with the accompanying drawings.

FIG. 1 is a block diagram of one embodiment of a personal device control arrangement of the present invention.

FIG. 2 is an example frontward-facing view within the passenger compartment of a vehicle including the personal device control arrangement of FIG. 1.

FIG. 3 is an example frontward-facing view within the passenger compartment of a centerstack display of the personal device control arrangement of FIG. 1.

FIG. 4 is a flow chart of one embodiment of a method of the present invention for providing infotainment within a motor vehicle.

### DETAILED DESCRIPTION OF THE PREFERRED EMBODIMENTS

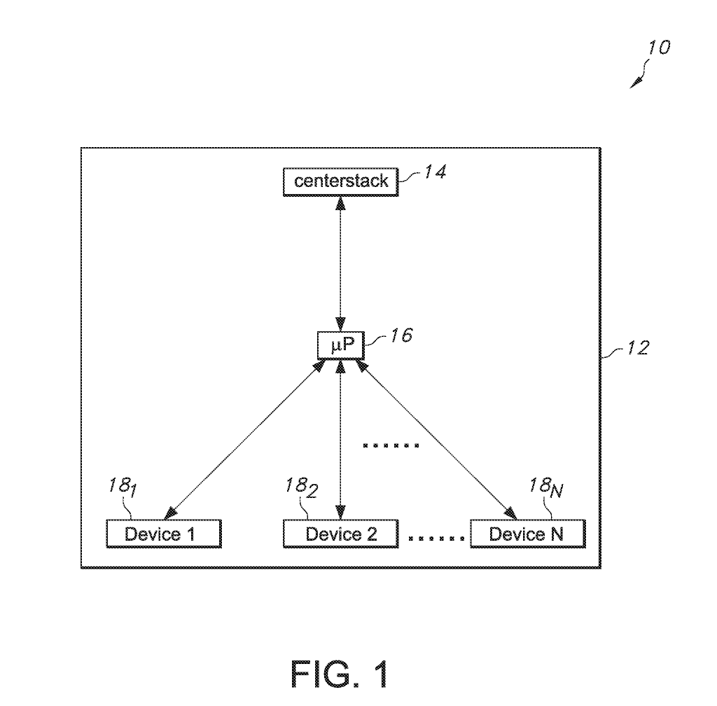

FIG. 1 illustrates one embodiment of a personal device control arrangement 10 of the present invention for a motor vehicle 12, including a centerstack 14, an electronic processor 16 and mobile personal electronic devices 18₁-18_{N}. Processor 16 may be in bi-directional communication with centerstack 14 and each of devices 18. Centerstack 14 may include a touch-sensitive display screen on which may be displayed the same content as is displayed on devices 18. The touch-sensitive display screen on centerstack 14 may enable a user in the front seat of vehicle 12 to control the operation of devices 18, and, more particularly, control what is being displayed on devices 18.

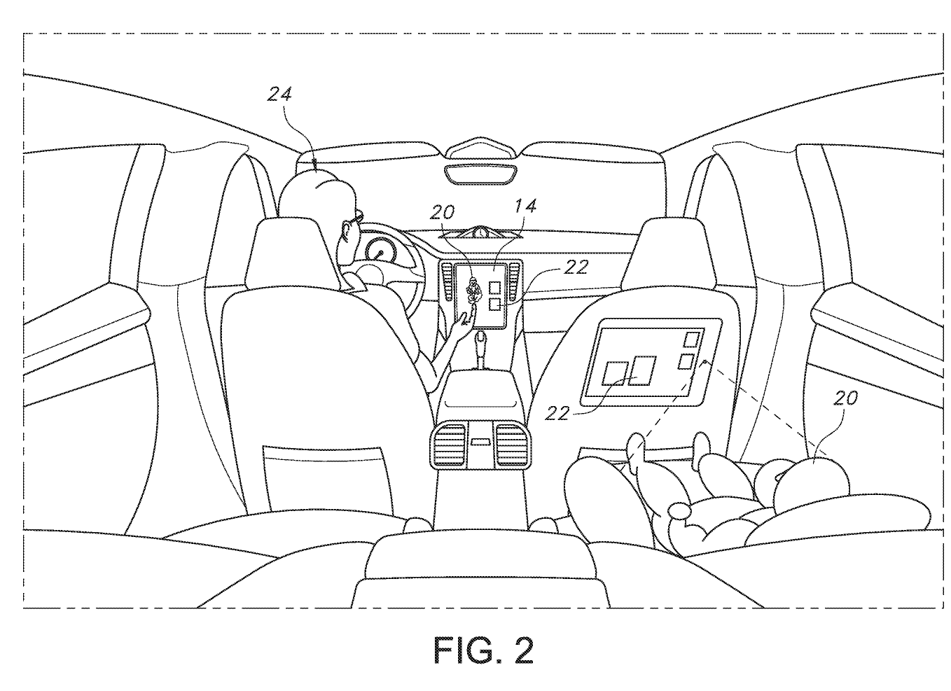

FIG. 2 is an example frontward-facing view within the passenger compartment of a vehicle 12 including the personal device control arrangement 10 of FIG. 1. A personal electronic device 18, such as a tablet computer, may be used as rear seat entertainment for an infant 20. On centerstack 14, infant 20 is displayed via a camera on device 18. Also displayed on centerstack 14 is the same content as displayed on device 18, i.e., the four blocks 22 are displayed on both centerstack 14 and device 18. A mother 24 of infant 20 can use centerstack 14 to control the content displayed on device 18.

In another embodiment (not shown), arrangement 10 is provided in the vehicle of a realtor who drives around a couple of clients in his backseat while they visit houses that are for sale. The clients bring their personal electronic device 18 into the rear seat. By use of arrangement 10, the realtor may share home listing information with the clients via their brought in device 18. The home listing information may be presented on the display screens of both centerstack 14 and device 18.

In yet another embodiment (not shown), arrangement 10 is provided in the vehicle of a family wherein a parent is driving in the front seat and two children are sitting in the rear seat. Each child brings into the vehicle his own device 18. Arrangement 10 enables the parent to selectively view one or both of the children via cameras on devices 18. Arrangement 10 may also enable the children to share content with each other so that they may view the same content simultaneously on their devices 18. For example, the two children may simultaneously view the same video from Youtube.com while the parent watches one or both of the children on centerstack 14.

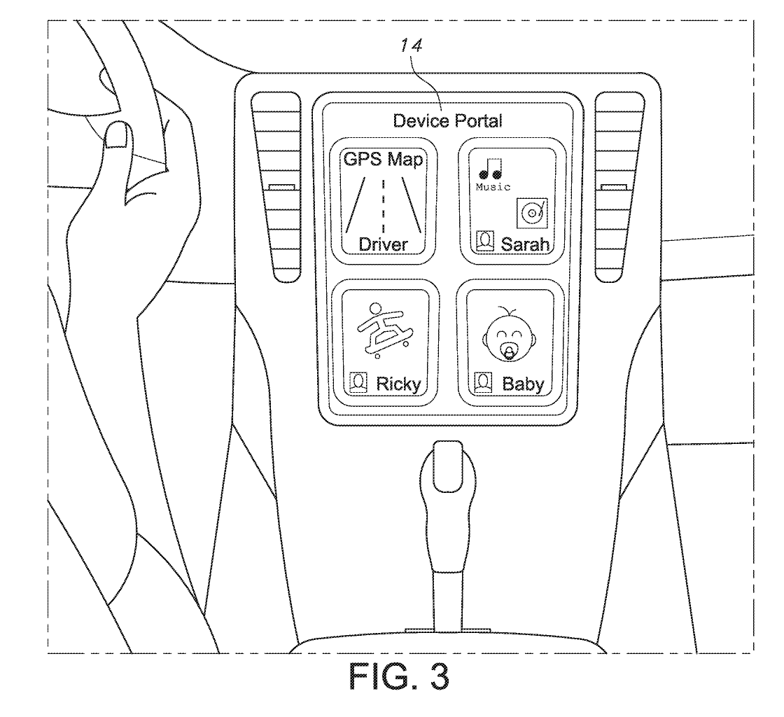

FIG. 3 illustrates an example centerstack display 14 of the personal device control arrangement 10 of FIG. 1. Centerstack display 14 includes a vehicle human machine interface screen that is in a “device portal” mode in which the screen displays the content that is being presented on each of the personal electronic devices 18 of the children inside the vehicle.

One quarter of display 14 may display an application that the driver is using for the driving task, such as a global positioning system (GPS) map. A second quarter displays a description of what content is being presented on child Sarah's device 18. In this example, display 14 presents a music icon indicating that Sarah's device 18 is playing music, and specifically, music by the group Goo Goo Dolls. A third quarter shows a video featuring skateboarding that child Ricky is watching. A fourth quarter shows a video that the infant is watching, an episode of “Dora the Explorer”. A picture-in-picture within the fourth quarter shows images of the infant captured by the camera of the infant's personal device 18. Each of the children's three quarters includes in the bottom left corner an icon or graphic representation of the respective child, so that the driver can see at a glance which quarter goes with which child. Each of the children's three quarters may also include at the bottom a textual identification of the respective child.

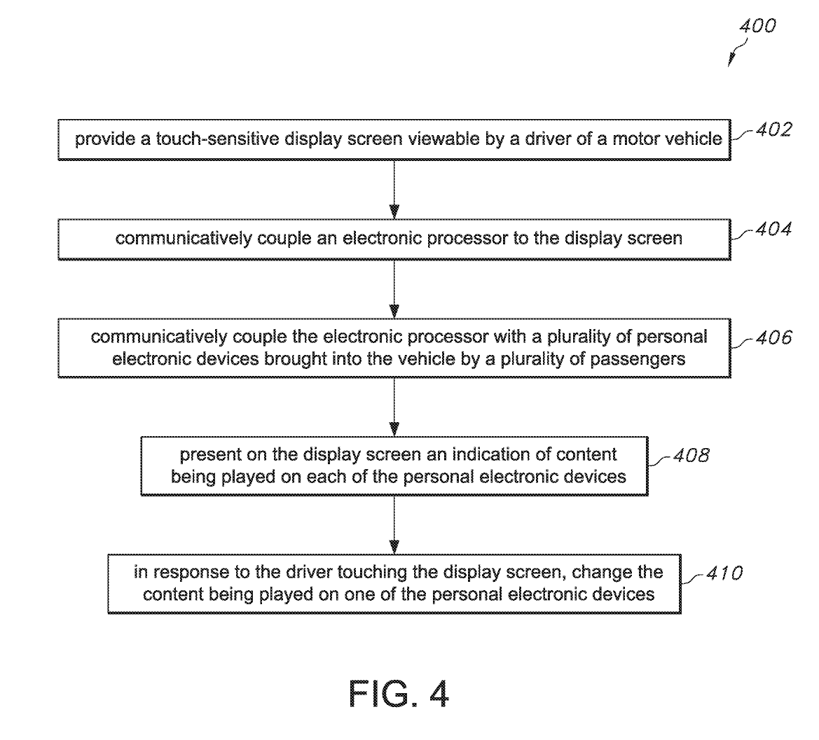

FIG. 4 illustrates one embodiment of a method 400 of the present invention for providing infotainment within a motor vehicle. In a first step 402, a touch-sensitive display screen viewable by a driver of the motor vehicle is provided. For example, a centerstack 14 including a touch-sensitive display screen may be provided.

Next, in step 404, an electronic processor is communicatively coupled to the display screen. For example, microprocessor 16 may communicate with the display screen of centerstack 14.

In a next step 406, the electronic processor is communicatively coupled with a plurality of personal electronic devices brought into the vehicle by a plurality of passengers. For example, microprocessor 16 may communicate with personal electronic devices 18₁-18_{N} brought into vehicle 12 by passengers.

In step 408, an indication of content being played on each of the personal electronic devices is presented on the display screen. For example, displayed on centerstack 14 may be the same content as displayed on a device 18, such as the four blocks 22 that may be displayed on both centerstack 14 and device 18.

In a final step 410, in response to the driver touching the display screen, the content being played on one of the personal electronic devices is changed. For example, the touch-sensitive display screen on centerstack 14 may enable a user in the front seat of vehicle 12 to control the operation of devices 18, and, more particularly, control what is being displayed on devices 18.

The invention has been described as the user interface being on the centerstack where content for controlling the device can be displayed. However, it is also possible within the scope of the invention for content for controlling the device to be displayed on other screens within vehicle such as the instrument cluster or on a head up display (HUD).

The protocol with which the vehicle connects to the device can be streaming, Bluetooth, low energy Bluetooth, near field communication (NFC), a wired connection to the device, etc.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detail description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
a display screen viewable by a driver of the motor vehicle; and
an electronic processor communicatively coupled to the display screen, the electronic processor being configured to:
bi-directionally communicate with a plurality of personal electronic devices brought into the vehicle by a plurality of passengers; and
present on the display screen an indication of content being played on each of the personal electronic devices.

2. The vehicle of claim 1 wherein the electronic processor is configured to, in response to the driver touching the display screen, change the content being played on one of the personal electronic devices.

3. The vehicle of claim 1 wherein the electronic processor is configured to present on the display screen an image captured by a camera of one of the personal electronic devices.

4. The vehicle of claim 1 wherein the electronic processor is configured to selectively present same content on the display screen and on each of the personal electronic devices simultaneously.

5. The vehicle of claim 1 wherein the content being played on one of the personal electronic devices is replicated on the display screen.

6. A method of providing infotainment within a motor vehicle, the method comprising:
providing a touch-sensitive display screen viewable by a driver of the motor vehicle;
communicatively coupling an electronic processor to the display screen;
communicatively coupling the electronic processor with a plurality of personal electronic devices brought into the vehicle by a plurality of passengers;
presenting on the display screen an indication of content being played on each of the personal electronic devices; and
in response to the driver touching the display screen, changing the content being played on one of the personal electronic devices.

7. The method of claim 6 further comprising presenting on the display screen an image captured by a camera of one of the personal electronic devices.

8. The method of claim 7 wherein the image is a real-time image of a user of the one personal electronic device.

9. The method of claim 6 further comprising presenting same content on the display screen and on each of the personal electronic devices simultaneously.

10. The method of claim 6 wherein the content being played on one of the personal electronic devices is replicated on the display screen.

11. A motor vehicle, comprising:
a display screen viewable by a driver of the motor vehicle; and
an electronic processor communicatively coupled to the display screen, the electronic processor being configured to:
bi-directionally communicate with a plurality of personal electronic devices brought into the vehicle by a plurality of passengers;
present on the display screen an indication of content being played on each of the personal electronic devices; and
present on the display screen an image captured by a camera of one of the personal electronic devices.

12. The vehicle of claim 1 wherein the image presented on the display screen is a real-time image captured by the camera less than one second before the image is captured on the display screen.

13. The vehicle of claim 11 wherein the display screen is touch-sensitive, and the electronic processor is configured to, in response to the driver touching the display screen, change the content being played on one of the personal electronic devices.

14. The vehicle of claim 11 wherein the electronic processor is configured to selectively present same content on the display screen and on each of the personal electronic devices simultaneously.

15. The vehicle of claim 11 wherein the content being played on one of the personal electronic devices is replicated on the display screen.

16. A motor vehicle, comprising:
a display screen viewable by a driver of the motor vehicle; and
an electronic processor communicatively coupled to the display screen, the electronic processor being configured to:
bi-directionally communicate with a plurality of personal electronic devices brought into the vehicle by a plurality of passengers; and
selectively present same content on the display screen and on each of the personal electronic devices simultaneously.

17. The vehicle of claim 16 wherein the electronic processor is configured to present on the display screen an indication of content being played on each of the personal electronic devices.

18. The vehicle of claim 16 wherein the display screen is touch-sensitive, and the electronic processor is configured to, in response to the driver touching the display screen, change the content being played on one of the personal electronic devices.

19. The vehicle of claim 16 wherein the electronic processor is configured to present on the display screen an image captured by a camera of one of the personal electronic devices.

20. The vehicle of claim 19 wherein the image is a real-time image of a user of the one personal electronic device.
